(19) United States
(12) Patent Application Publication
(10) Pub. No.: US 2016/0286944 A1
(43) Pub. Date: Oct. 6, 2016

(54) MAGNETIC ATTACHMENTS FOR PORTABLE ELECTRONIC DEVICES

(71) Applicant: Reginald Snyder, Mableton, GA (US)

(72) Inventor: Reginald Snyder, Mableton, GA (US)

(21) Appl. No.: 14/678,559

(22) Filed: Apr. 3, 2015

(51) Int. Cl. A45F 5/00; F16B 1/00; A45F 5/02; F16M 13/04

(52) U.S. Cl. CPC A45F 5/00; F16M 13/04; F16B 1/00; A45F 5/02; F16B 2001/0035; A45F 2005/008; A45F 2200/0516

(57) ABSTRACT

Implementations of magnetic attachments for mounting a mobile phone or other portable electronic device to a user's body are provided. In some implementations, a first magnetic attachment device comprises a first plate having embedded therein one or more magnets, a second plate, and a connector. The connector piece connects the first plate to the second plate thereby forming a gap between the first plate to the second plate. In some implementations, the first magnetic attachment device may be secured to a belt or other article of clothing worn by the user via the gap and then the portable electronic device may be magnetically attached to the first plate.

### TECHNICAL FIELD

This disclosure relates to implementations of magnetic attachments for portable electronic devices.

### BACKGROUND

Mounts exists to secure mobile phone in a particular location in a car. These car mount systems come in a variety of configurations. Typically, one portion of the mount releasably attaches to a portion of a car and another portion of the mount releasably attaches to the mobile phone. However, there are few options for mounting a mobile phone or other portable electronic device to a user's body. Existing cell phone cases that can mount to a user's belt may be configured as a pouch and thus limit the size and shape of cell phones that can use the cell phone cases. Also, retrieving the cell phone from these cell phone cases can be cumbersome. Other cell phone mounts may be integrated into the cell phone case, which can be bulky and/or unsightly.

### BRIEF DESCRIPTION OF THE DRAWINGS

FIGS. 1A-1D illustrate an implementation of an example magnetic attachment device according to the principles of the present disclosure.

FIGS. 2A-2C illustrate an implementation of another example magnetic attachment device 200 according to the principles of the present disclosure.

FIG. 3 illustrates an implementation of another example magnetic attachment device according to the principles of the present disclosure.

FIG. 4 illustrates an implementation of another example magnetic attachment device according to the principles of the present disclosure.

### DETAILED DESCRIPTION

Implementations of magnetic attachments for mounting a mobile phone or other portable electronic device to a user's body are provided. In some implementations, a first magnetic attachment device comprises a first plate having embedded therein one or more magnets, a second plate, and a connector. The connector piece connects the first plate to the second plate thereby forming a gap between the first plate to the second plate. In some implementations, the first magnetic attachment device may be secured to a belt or other article of clothing worn by the user via the gap and then the portable electronic device may be magnetically attached to the first plate. In some implementations, the second plate may have one or more magnets embedded within the second plate. In this way, the second plate may be magnetically attached to another object and then the portable electronic device may be magnetically attached to the first plate. In some implementations, the first plate is made from a ferromagnetic material and the phone is magnetic.

In some implementations, a second magnetic attachment device comprises a first plate having embedded therein one or more magnets, a first band extending from a first side of the first plate, and a second band extending from a second side of the first plate 310. In some implementations, the ends of the bands may include a fastener to secure the first band to the second band. The second magnetic attachment device may be used to mount a portable electronic device to a user's body by placing the first plate at a desired location on an appendage (such as an arm, leg, or wrist), wrapping the bands around the appendage, securing the bands around the appendage using the fasteners, and magnetically attaching the portable electronic device to the first plate.

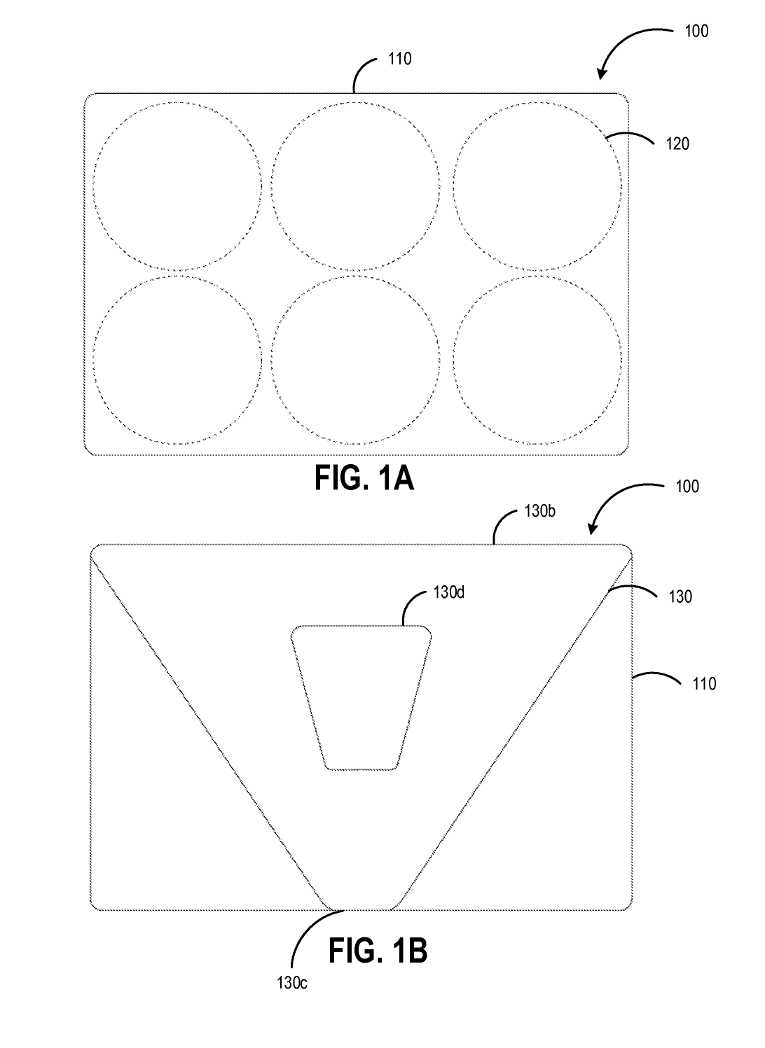

FIGS. 1A-1C illustrate an implementation of an example magnetic attachment device 100 according to the principles of the present disclosure for mounting a mobile phone or other portable electronic device to a user's body. The portable electronic device may be any type of portable or mobile electronics device, such as for example, a smartphone, a cell phone, personal digital assistant (PDA), laptop computer, tablet-style computer, or any other device that a user may hold in his or her hand.

FIG. 1A is an example front view of the magnetic attachment device 100; FIG. 1B is an example back view of the magnetic attachment device 100; and FIG. 1C is an example side view of the magnetic attachment device 100.

In some implementations, the magnetic attachment device 100 may comprise a first plate 110 having embedded therein one or more magnets 120, a second plate 130, and a connector 140. As shown in FIG. 1C, the magnetic attachment device 100 is arranged such that a first surface 110a of the first plate 110 faces a first surface 130a of the second plate 130 and the connector piece 140 connects a first end of the first plate 110 to a first end of the second plate 130 thereby forming a gap 150 between the first surface 110a and second surface 130a.

In some implementations, the magnetic attachment device 100 can be used to mount a mobile phone or other portable electronic device to a user's body. For example, as shown in FIG. 1D, if a user is wearing a belt 160, the magnetic attachment device 100 can be placed over the top of the belt such that a portion of the belt 160 may be received by the gap 150 when the magnetic attachment device 100 moved toward the belt. In some implementations, the magnetic attachment device 100 can be placed over the top of a pair of pants or any other article of clothing.

Once the magnetic attachment device 100 is secured to the user's body by securing the magnetic attachment 100 to an article of clothing worn by the user, the portable electronic device 170 may be magnetically attached to the first plate 110 by bringing the portable electronic device 170 into contact with the first plate 110.

In some implementations, a piece of ferromagnetic material such as metal may be placed within the portable electronic device 170 to achieve the magnetic attachment. For example, in some implementations, a portion of the outside surface of a phone may be removed, then a thin metal plate may be placed inside the phone, and the removed surface then may be secured back on the phone. The phone may then be brought into contact with the first plate 110 to achieve a magnetic attachment.

In some implementations, one or more magnets that attract to the magnet(s) in the first plate 110 may be placed between the portable electronic device 170 (e.g., a smart phone) and a case configured to fit around the portable electronic device. Then the case may be brought into contact with the first plate 110 to achieve a magnetic attachment.

In some implementations, a case configured to fit around the portable electronic device may be manufactured from a ferromagnetic material such as metal. The case may be placed on the portable electronic device and then the case may be brought into contact with the first plate 110 to achieve a magnetic attachment.

In some implementations, the first plate 110 may be metal and a case configured to fit around the portable electronic device may be magnetic. The case may be placed on the portable electronic device and then the case may be brought into contact with the first plate 110 to achieve a magnetic attachment.

In some implementations, the first plate 110 may be rectangular. In some implementations, the first plate 110 may be any suitable shape.

In some implementations the first plate 110 may be 3 inches in height and at least 2 inches in width. In some implementations, the first plate 110 may be shorter or taller than 3 inches. In some implementations the first plate 110 may be narrower or wider than 2 inches.

As shown in FIG. 1A, in some implementations, a matrix of circular magnets 120 may be arranged inside plate 110. In some implementations, the matrix of magnets may be 2×3. In some implementations, the one or more magnets may be arranged in any suitable fashion. In some implementations, the magnets may be 1 inch in diameter and 1/16 inches thick. In some implementations, the magnets may be smaller or larger in diameter and/or thickness. In some implementations, the magnets may be neodymium disc magnets. In some implementations, the magnets can be any suitable shape or size. In some implementations, the strength of the magnets can be any suitable strength. In some implementations, the magnets can be any suitable magnet.

As shown in FIG. 1B, in some implementations, the second plate 130 may have a tapered shape such that the first end 130b of the second plate is wider than the second end 130c. In some implementations, the second plate 130 may be triangular. In some implementations, the second plate 130 may be any suitable shape.

In some implementations, the second plate 130 may include an opening 130d through the plate 130. In some implementation, a wearer my insert his or her finger in the opening 130d to facilitate removing the magnetic attachment device 100 from an article of clothing.

In some implementations, the second plate 130 may include a lip 130e along the second end 130c of the second plate 130. The lip 130e may help to retain the belt 160 inside the gap 150 of the magnetic attachment device 100.

In some implementations, the second plate 130 may have one or more magnets embedded within the second plate 130. In some implementations, the magnet(s) in the second plate 130 may be designed to attract to the magnet(s) in the first plate 110. In this way, the magnetic attachment device 100 may more securely grasps an article of clothing within the gap 150. Also, the magnetic attachment device 100 may be magnetically attached to another object by bringing the second plate 130 into contact with another object (e.g., a metal object or ferromagnetic object). Then, the portable electronic device may be attached to the first plate 110.

In some implementations, the first plate, the second plate, and the connector may be manufactured from plastic, metal, or any other suitable material, or a combination of the foregoing.

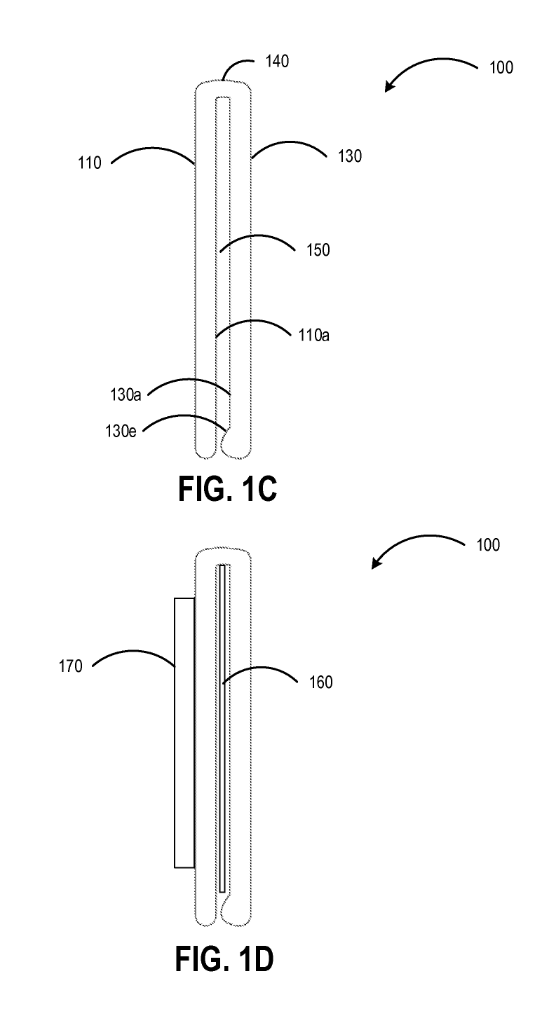

FIGS. 2A-2C illustrate an implementation of another example magnetic attachment device 200 according to the principles of the present disclosure for mounting a mobile phone or other portable electronic device to a user's body.

FIG. 2A is an example front view of the magnetic attachment device 200; FIG. 2B is an example back view of the magnetic attachment device 200; and FIG. 2C is an example side view of the magnetic attachment device 200.

In some implementations, the magnetic attachment device 200 may comprise a first magnet 210, a second magnet 230, and a connector 240. As shown in FIG. 2C, the magnetic attachment device 200 is arranged such that a first surface 210a of the first magnet 210 faces a first surface 230a of the second magnet 230 and the connector piece 240 connects the first magnet 210 to the second magnet 230 thereby forming a gap 250 between the first surface 210a and second surface 230a.

In some implementations, the magnets 210, 230 may be 1 inch in diameter and 1/16 inches thick. In some implementations, the magnets 210, 230 may be 1 inch in diameter and 1/32 inches thick. In some implementations, the magnets may be smaller or larger in diameter and/or thickness. In some implementations, the magnets may be neodymium disc magnets. In some implementations, the magnets can be any suitable shape or size. In some implementations, the strength of the magnets can be any suitable strength. In some implementations, the magnets can be any suitable magnet.

In some implementations, the second magnet 230 may be designed to attract to the first magnet 230. In this way, the magnetic attachment device 200 may more securely grasps an article of clothing within the gap 250.

The magnetic attachment device 200 may be used in a similar manner to the magnetic attachment device 100.

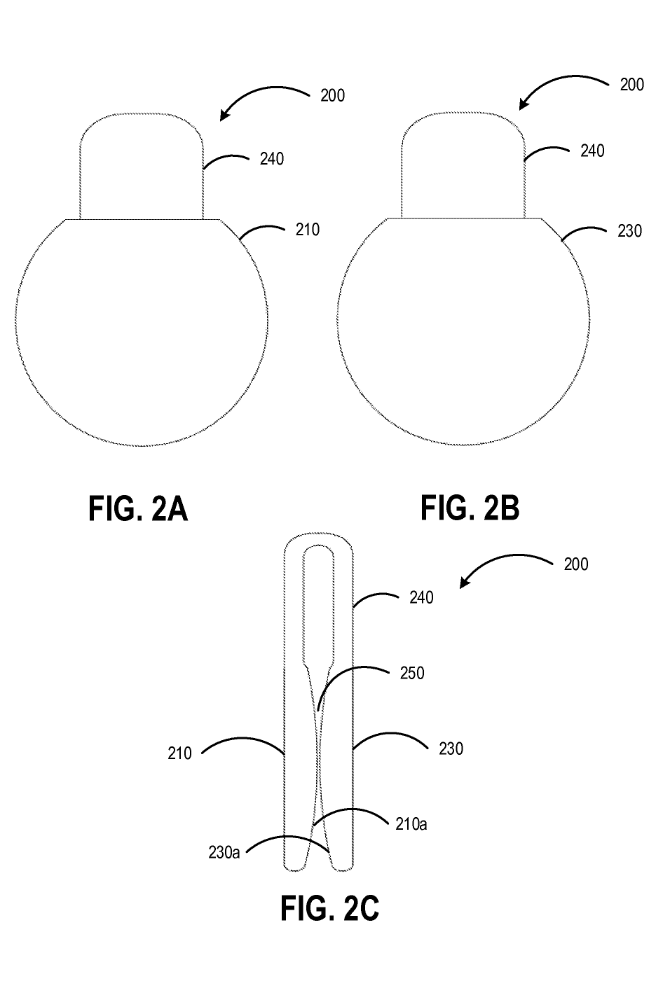

FIG. 3 illustrates an implementation of another example magnetic attachment device 300 according to the principles of the present disclosure for mounting a portable electronic device to a user's body.

In some implementations, the magnetic attachment device 300 may comprise a first plate 310 having embedded therein one or more magnets 320, a first band 330 extending from a first side of the first plate 310, and a second band 340 extending from a second side of the first plate 310. In some implementations the ends of the bands 330, 340 include fasteners 350a, b to secure the first band 330 to the second band 340. In some implementations, the fasteners 350a, b may be snaps (e.g., the male 350a and female portions 350b of a snap); buttons (e.g., a button 350a and slit 350b); magnets; hook (e.g., 350a) and loop (e.g., 350b) fasteners (e.g., Velcro®); or other reclosable fasteners or fastening technology existing or developed in the future. Fastener 350a may be on the side of the band 330 opposite the side of the band 340 that the fastener 350b is on for the fasteners to work properly. For example, fastener 350a may be on the front side of the band 330 and fastener 350b may be on the back side of the band 330 or vice-versa.

In some implementations, the magnetic attachment device 300 can be used to mount a mobile phone or other portable electronic device to a user's body. For example, in some implementations, the bands 330, 340 may be secured around a person arm or leg by placing the first plate 310 at a desired location on an arm or leg and then wrapping the bands around the arm or leg and securing the bands around the arm or leg using the fasteners 350a, b. Once the magnetic attachment device 100 is secured to the user's body, a portable electronic device may be magnetically attached to the first plate 310 by bringing the portable electronic device into contact with the first plate 310 as discussed above.

The magnets 320 may be similar to the magnets 120. In some implementations, the first plate 310 may be manufactured from plastic, metal, or any other suitable material. In some implementations, the bands 330, 340 may be manufactured from a stretchable material or any other suitable material.

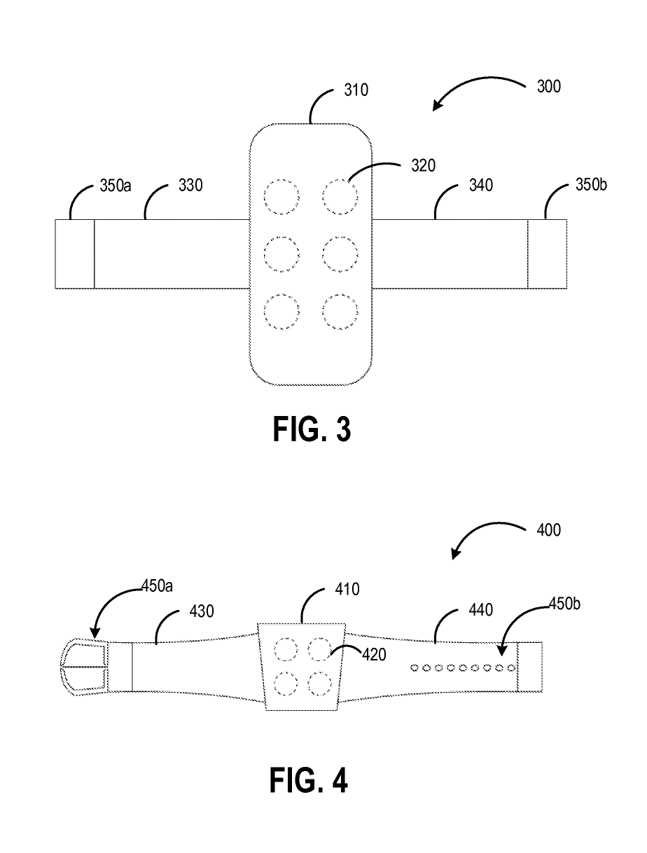

FIG. 4 illustrates an implementation of another example magnetic attachment device 400 according to the principles of the present disclosure for mounting a portable electronic device to a user's body.

In some implementations, the magnetic attachment device 400 may comprise a first plate 410 having embedded therein one or more magnets 420, a first band 430 extending from a first side of the first plate 410, and a second band 440 extending from a second side of the first plate 410. In some implementations the ends of the bands 430, 440 include fasteners 450a, b to secure the first band 430 to the second band 440.

In some implementations, the magnetic attachment device 400 may be similar to magnetic attachment device 300 except that magnetic attachment device 400 is configured to be secured around a wrist. Accordingly, the magnetic attachment device 400 may be smaller than magnetic attachment device 300. For example, the first plate 410 may be smaller and have fewer and/or smaller magnets 420 than first plate 310. For example, the magnets 420 may be ¼ inches in diameter and 1/16 inches thick. In some implementations, the magnets 420 may be smaller or larger in diameter and/or thickness.

In some implementations, the fasteners 450a, b may be any fastening technology existing or developed in the future as discussed above. For example, as shown in FIG. 4, in some implementations, the fasteners 450a, b may be a buckle (450a) and hole (450b).

In some implementations the bands 430, 440 may be manufactured from plastic, leather, or any other suitable material.

The magnetic attachment device 400 may be used in a similar fashion to the magnetic attachment device 300 to mount a portable electronic device (such as a portable media player) to a user's wrist.

Reference throughout this specification to “an embodiment” or “an implementation” or words of similar import means that a particular described feature, structure, or characteristic is included in at least one embodiment of the present invention. Thus, the phrase “in an embodiment” or “an implementation” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A magnetic attachment device comprising:
a first plate having embedded therein one or more magnets;
a second plate; and
a connector wherein a first surface of the first plate faces a first surface of the second plate and the connector connects a first end of the first plate to a first end of the second plate thereby forming a gap between the first surface of the first plate and the first surface of the second plate.

2. The magnetic attachment device of claim 1 wherein the second plate is tapered such that the first end of the second plate is wider than the second end of the second plate.

3. The magnetic attachment device of claim 2 wherein the second plate includes an opening through the second plate.

4. The magnetic attachment device of claim 3 wherein the second plate includes a lip along the second end of the second plate.

5. The magnetic attachment device of claim 1 wherein the second plate comprises one or more magnets embedded within the second plate.

6. The magnetic attachment device of claim 5 wherein the one or more magnets within the second plate are configured to attract to the one or more magnets in the first plate.

7. A method for mounting a portable electronic device to a user's body using the magnetic attachment device of claim 1, the method comprising:
placing an article of clothing worn by a user in the gap between the first surface of the first plate and the first surface of the second plate; and
magnetically attaching the portable electronic device to the first plate.

8. The method of claim 7 wherein the portable electronic device is a mobile phone.

9. The method of claim 7 wherein magnetically attaching the portable electronic device to the first plate comprises placing a piece of ferromagnetic material within the portable electronic device and then bringing the portable electronic device into contact with the first plate.

10. The method of claim 7 wherein magnetically attaching the portable electronic device to the first plate comprises placing one or more magnets between the portable electronic device and a case placed on the portable electronic device and then bringing the case into contact with the first plate, wherein the one or more magnets between the portable electronic device and the case are configured to attract to the one or more magnets in the first plate.

11. The method of claim 7 wherein magnetically attaching the portable electronic device to the first plate comprises placing a case manufactured from a ferromagnetic material on the portable electronic device and then bringing the case into contact with the first plate.

12. The method of claim 7 wherein the first plate does not include one or more magnets but instead comprises a ferromagnetic material and magnetically attaching the portable electronic device to the first plate comprises placing a magnetic case on the portable electronic device and then bringing the case into contact with the first plate.

13. A method for mounting a portable electronic device to an object using the magnetic attachment device of claim 5, the method comprising:
magnetically attaching the second plate to a ferromagnetic object; and
magnetically attaching the portable electronic device to the first plate.

14. The method of claim 13 wherein the portable electronic device is a mobile phone.

15. The method of claim 13 wherein magnetically attaching the portable electronic device to the first plate comprises placing a piece of ferromagnetic material within the portable electronic device and then bringing the portable electronic device into contact with the first plate.

16. The method of claim 13 wherein magnetically attaching the portable electronic device to the first plate comprises placing one or more magnets between the portable electronic device and a case placed on the portable electronic device and then bringing the case into contact with the first plate, wherein the one or more magnets between the portable electronic device and the case are configured to attract to the one or more magnets in the first plate.

17. The method of claim 13 wherein magnetically attaching the portable electronic device to the first plate comprises placing a case manufactured from a ferromagnetic material on the portable electronic device and then bringing the case into contact with the first plate.

18. The method of claim 13 wherein the first plate does not include one or more magnets but instead comprises a ferromagnetic material and magnetically attaching the portable electronic device to the first plate comprises placing a magnetic case on the portable electronic device and then bringing the case into contact with the first plate.

19. A magnetic attachment device comprising:
a first plate having embedded therein one or more magnets;
a first band extending from a first side of the first plate; and
a second band extending from a second side of the first plate wherein the ends of the bands include a fastener to secure the first band to the second band.

20. A method for mounting a portable electronic device to a user's body using the magnetic attachment device of claim 17, the method comprising:
placing the first plate at a desired location on an appendage;
wrapping the bands around the appendage;
securing the bands around the appendage using the fasteners; and
magnetically attaching the portable electronic device to the first plate.
